(19) United States
(12) Patent Application Publication
(10) Pub. No.: US 2026/0188853 A1
(43) Pub. Date: Jul. 2, 2026

(54) TERMINAL AND BUSBAR FIXING STRUCTURE, AND BATTERY PACK

(71) Applicant: TOYOTA JIDOSHA KABUSHIKI KAISHA, Toyota-shi (JP)

(72) Inventors: Tomo FUKAMI, Nagoya-shi (JP); Yoshinori SHIBATA, Nagoya-shi (JP); Takumi SHIGENO, Toyota-shi (JP)

(73) Assignee: TOYOTA JIDOSHA KABUSHIKI KAISHA, Toyota-shi (JP)

(21) Appl. No.: 19/338,364

(22) Filed: Sep. 24, 2025

(30) Foreign Application Priority Data
Dec. 27, 2024 (JP) 2024-233041

(51) Int. Cl. H01M 50/507; H01M 50/209; H01M 50/503; H01M 50/516; H01M 50/566

(52) U.S. Cl. CPC H01M 50/507; H01M 50/209; H01M 50/503; H01M 50/516; H01M 50/566

(57) ABSTRACT

The present disclosure relates to a terminal and busbar fixing structure, and to a battery pack. The terminal and busbar fixing structure includes a pair of external terminal, each including a flat plate portion, and a clip-shaped busbar that clamps each of the flat plate portions and also is welded to each of the flat plate portions.

### CROSS-REFERENCE TO RELATED APPLICATION

This application claims priority to Japanese Patent Application No. 2024-233041 filed on Dec. 27, 2024. The disclosure of the above-identified application, including the specification, drawings, and claims, is incorporated by reference herein in its entirety.

### BACKGROUND

### 1. Technical Field

The present disclosure relates to a terminal and busbar fixing structure, and to a battery pack.

### 2. Description of Related Art

A terminal joining structure of a busbar that is disclosed in Japanese Unexamined Patent Application Publication No. 2024-030576 (JP 2024-030576 A) in which is disposed a welded portion that has a joining face to be joined by welding to a distal end portion of a rod-shaped terminal, and a terminal holding portion that is provided at a position spaced apart from the welded portion, and that has a base end of the terminal inserted therein to limit movement of the terminal at the welded portion. This enables a positional relation between a joining site of the busbar and the terminal to be stably maintained when joining the busbar and the terminal of an electronic device by welding, thereby obtaining a good joining state.

### SUMMARY

Now, with regard to in-vehicle batteries, there are cases in which a cell-to-pack system is adopted in which a battery module is eliminated and a combination of battery cells is simply installed in a vehicle as a battery pack. When manufacturing battery packs using the cell-to-pack method, the terminals of a plurality of the battery cells are fixed together using a busbar, but there is a problem in which fixing the terminals and the busbar by crimping alone leads to a situation in which resistance value increases due to oxidation of an interface due to deterioration over time. On the other hand, when fixing the terminal and the busbar by welding, a pressing tool is used to press the busbar from above and measure a gap between the busbar and the terminal, which requires space in a heightwise direction of the battery pack. As a result, it becomes difficult to reduce the size of the battery pack in the heightwise direction, and to improve stacking efficiency of the battery cells within the battery pack.

The present disclosure has been made in light of the above circumstances, and an object of thereof is to provide a terminal and busbar fixing structure, and a battery pack, whereby the terminal and the busbar can be fixed in a space-saving and appropriate manner.

A terminal and busbar fixing structure according to a first aspect includes a pair of terminals, each including a flat plate portion that is shaped as a flat plate, and a clip-shaped busbar that clamps each of the flat plate portions and also is welded to each of the flat plate portions.

In the first aspect, the flat-plate-shaped flat plate portions of the terminals are clamped by a clip-shaped busbar, and welded to the busbar. In this way, clamping the flat plate portion of each of the terminals by the busbar enables welding to be performed in a state in which there is a constant gap between each of the flat plate portions and the busbar, and also welding can be performed in a narrow space. Thus, the terminal and the busbar can be fixed as appropriate in a space-saving manner.

With the terminal and busbar fixing structure of according to a second aspect, in the first aspect, the flat plate portions are clamped by the busbar in a state of being butted against each other.

In the second aspect, the flat plate portions of the terminals are butted against each other, and clamped by the busbar and welded in this state, and accordingly each of the flat plate portions can be easily welded to the busbar equivalently.

With the terminal and busbar fixing structure according to a third aspect, in the first aspect, the flat plate portions are clamped by the busbar in a state of being overlaid on each other.

In the third aspect, the flat plate portions of the terminals are overlaid on each other, and clamped by the busbar and welded in this state, and accordingly the space that is required for disposing the terminals can be reduced more easily as compared with the second aspect.

A battery pack according to a fourth aspect includes a battery case, a plurality of battery cells that are housed arrayed in the battery case, each of the battery cells including a terminal with a flat plate portion that is shaped as a flat plate, and a plurality of clip-shaped busbars that clamps each of the flat plate portions of the battery cells that are adjacent to each other, and also is welded to each of the flat plate portions.

In the fourth aspect, a terminal having a plate-shaped flat plate portion is provided to each of the battery cells housed arrayed in the battery case. The flat plate portions of battery cells that are adjacent to each other are clamped by a clip-shaped busbar and also welded to the busbar. In this way, clamping the flat plate portion of each of the terminals by the busbar enables welding to be performed in a state in which there is a constant gap between each of the flat plate portions and the busbar, and also welding can be performed in a narrow space. Thus, the terminal and the busbar can be fixed as appropriate in a space-saving manner.

As described above, the terminal and busbar fixing structure and the battery pack according to the present disclosure can fix the terminal and the busbar as appropriate in a space-saving manner.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view illustrating a main portion of a battery pack according to an embodiment;

FIG. 2 is a perspective view illustrating part of the battery pack;

FIG. 3 is a perspective view illustrating a state before a busbar is attached to terminals of battery cells that are adjacent to each other;

FIG. 4 is a perspective view illustrating the busbar;

FIG. 5 is a perspective view illustrating a modification in which terminals of battery cells that are adjacent to each other are overlaid on each other in a heightwise direction of a battery pack;

FIG. 6 is a perspective view illustrating a modification in which terminals of battery cells that are adjacent to each other are butted against each other;

FIG. 7 is a perspective view illustrating a main portion of a battery pack according to a comparative example; and

FIG. 8 is a perspective view illustrating a state in which a busbar is pressed against a terminal of a battery cell by a pressing jig in the comparative example.

### DETAILED DESCRIPTION OF EMBODIMENTS

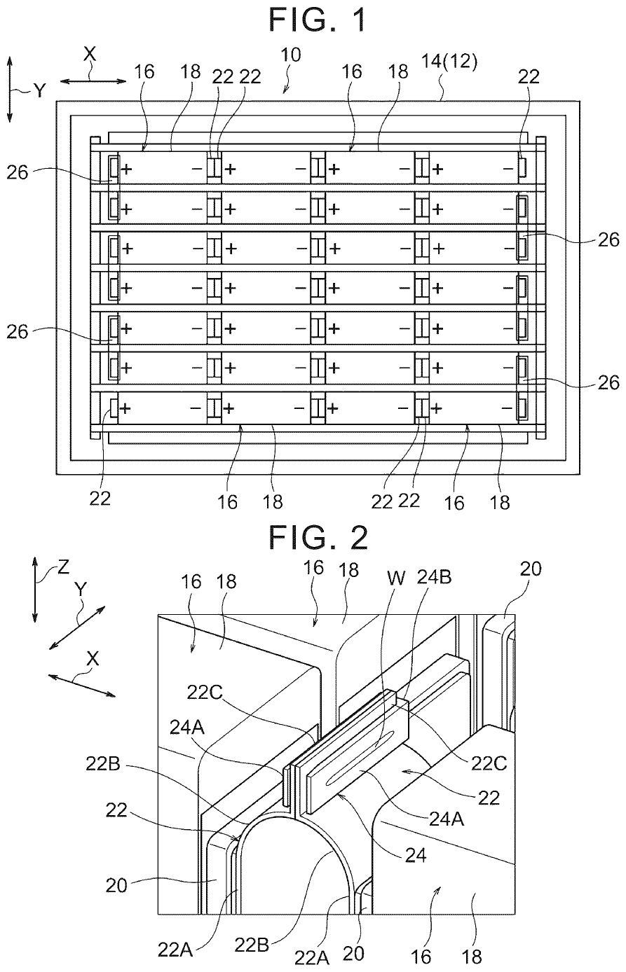

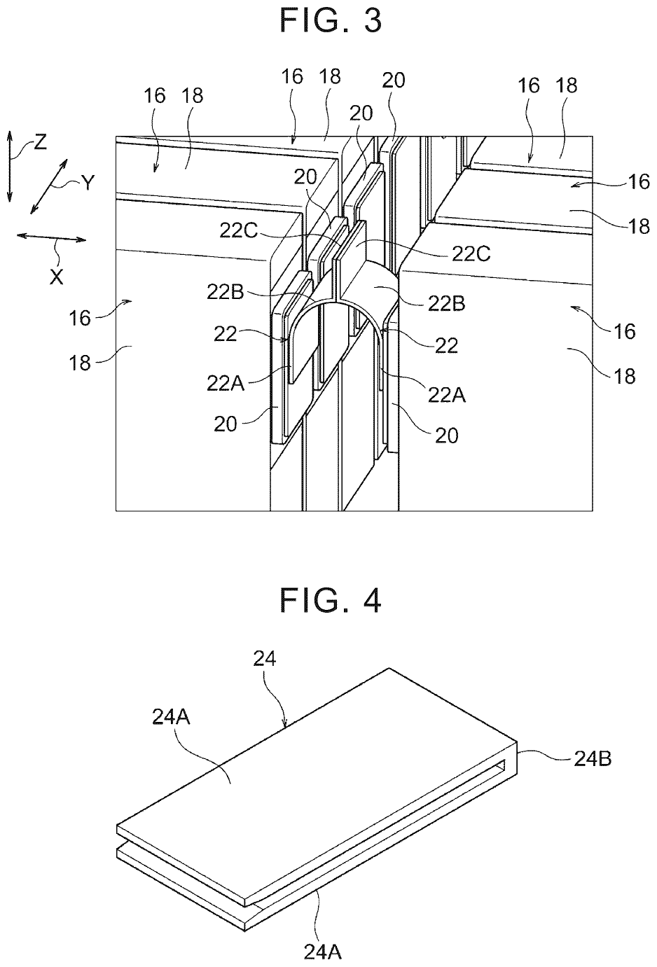

A battery pack 10 according to an embodiment of the present disclosure will be described below with reference to FIGS. 1 to 6. Note that in each drawing, some reference numerals may be omitted in order to facilitate understanding of the drawing.

### Configuration

As illustrated in FIG. 1, the battery pack 10 according to the present embodiment is installed in a vehicle such as a battery electric vehicle, a hybrid electric vehicle, a fuel cell electric vehicle, a solar car, or the like, and includes a battery case 12 and a plurality of (here, a great number of) battery cells 16 housed within the battery case 12. The battery case 12 has a case body 14 that is flat, box-shaped, and that is open on an upward side, and a cover, omitted from illustration, that closes the opening of the case body 14. The case body 14 and the cover have rectangular shapes in plan view. Note that arrow X, arrow Y, and arrow Z, which are in each drawing as appropriate, indicate the lengthwise direction, widthwise direction, and heightwise direction (up-down direction), respectively, of the battery pack 10 and the battery case 12.

As illustrated in FIGS. 1 to 3, the battery cells 16 are, for example, lithium ion secondary battery cells, each having a cell body 18 that is cuboid-shaped. A great number of the battery cells 16 are housed inside the battery case 12, arrayed in the lengthwise direction and the widthwise direction of the battery case 12. Each of the battery cells 16 is disposed in the battery case 12, oriented with the lengthwise direction of the battery case 12 as the lengthwise direction thereof, the heightwise direction of the battery case 12 as the heightwise direction thereof, and the widthwise direction of the battery case 12 as the widthwise direction thereof.

A positive electrode terminal 20 (omitted from illustration in FIG. 1) is provided on one end face of the cell body 18 in the lengthwise direction, and a negative electrode terminal 20 (omitted from illustration in FIG. 1) is provided on the other end face of the cell body 18 in the lengthwise direction. Each of external terminals 22 is fixed to each of the positive and the negative electrode terminals 20. The external terminal 22 corresponds to “terminal” in the present disclosure.

The electrode terminal 20 is manufactured by press-forming an aluminum alloy plate material, for example, and has an elongated plate shape. The electrode terminals 20 are disposed in an orientation in which the lengthwise direction of the cell body 18 is a plate thickness direction, and the widthwise direction of the cell body 18 (heightwise direction of battery case 12) is the lengthwise direction.

The external terminal 22 is manufactured by performing pressing-forming of an aluminum alloy plate material, for example, and has a plate shape with a substantially Z-shaped cross section (substantially crank-shaped cross section). The external terminal 22 is made up of a fixing portion 22A that is overlaid on an upper part of the electrode terminal 20 in the plate thickness direction, a curved portion 22B that extends from an upper end portion of the fixing portion 22A on a side opposite from the cell body 18 and also to an upward side in the heightwise direction of the battery case 12, and a flat plate portion 22C that extends to the upward side from a distal end portion of the curved portion 22B in the heightwise direction of the battery case 12.

The fixing portion 22A and the flat plate portion 22C are flat-plate shaped, with the plate thickness direction being the lengthwise direction of the battery case 12. The curved portion 22B is curved in an arcuate shape as viewed in the widthwise direction of the battery case 12. The fixing portion 22A is fixed to the electrode terminal 20 by welding, for example. Note that a configuration may be made in which each of the electrode terminals 20 and each of the external terminals 22 are integrally manufactured.

Battery cells 16 that are adjacent to each other in the lengthwise direction of the battery case 12 are disposed in a state in which the flat plate portions 22C of the external terminals 22 thereof overlay each other in the lengthwise direction of the battery case 12. Dimensional error between battery cells 16 that are adjacent to each other as described above is absorbed by elastic deformation of the curved portions 22B of the external terminals 22 in this configuration. As illustrated in FIG. 2, the flat plate portions 22C that are overlaid on each other as described above are clamped by a busbar 24 that is clip-shaped (omitted from illustration in FIG. 1). Note that in FIG. 2, to facilitate viewing, only one set of external terminals 22 is illustrated, and only one busbar 24 is illustrated.

The busbar 24 is manufactured by bending an aluminum alloy plate member, for example. As illustrated in FIG. 4, the busbar 24 integrally has a pair of clamping portions 24A that is elongated and plate-shaped, and face each other in the plate thickness direction, and a connecting portion 24B connecting one end portion in the lengthwise direction of each of the clamping portions 24A, and has a substantially U-shaped cross section.

A dimension between the clamping portions 24A is set to be equal to a thickness dimension of a pair of the flat plate portions 22C overlaid as described above. The flat plate portions 22C are disposed between the clamping portions 24A and are clamped in the plate thickness direction by the clamping portions 24A. The clamping portions 24A and the flat plate portions 22C are welded (joined, fixed) at a weld site W illustrated in FIG. 2. The welding method for this weld site W is, for example, laser welding. Thus, out of battery cells 16 that are adjacent to each other, the positive electrode terminal 20 that is provided on one, and the negative electrode terminal 20 that is provided on the other, are electrically connected via the external terminals 22.

As illustrated in FIG. 1, on both sides of the battery case 12 in the lengthwise direction, a positive electrode terminal 20 (reference number omitted in FIG. 1) that is provided on one of the battery cells 16 that are adjacent to each other in the widthwise direction of the battery case 12 is electrically connected to a negative electrode terminal 20 (reference number omitted in FIG. 1) that is provided on the other via external terminals 22 and a busbar 26.

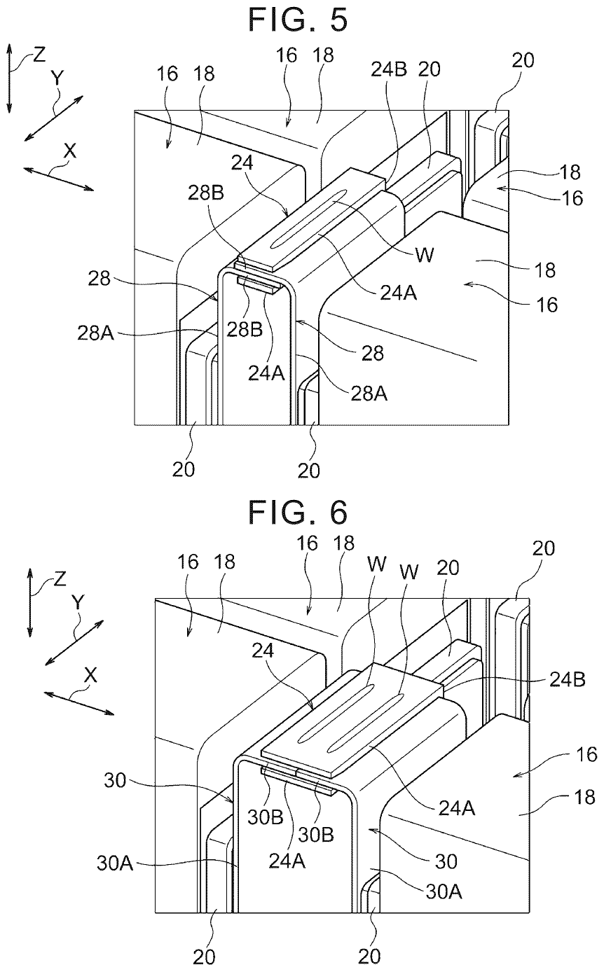

It should be noted that the present disclosure is not limited to the above-described configuration in which the flat plate portions 22C are overlaid in the lengthwise direction of the battery case 12. For example, a configuration may be made in which a pair of the flat plate portions 28B is overlaid in the heightwise direction of the battery case 12, as in a first modification that is illustrated in FIG. 5, or a configuration may be made in which a pair of the flat plate portions 30B is butted against each other in the lengthwise direction of the battery case 12, as in a second modification that is illustrated in FIG. 6.

In the first modification illustrated in FIG. 5, an external terminal 28 is made up of a fixing portion 28A that is overlaid in the plate thickness direction on the upper part of the electrode terminal 20, and the flat plate portion 28B that extends from an upper end portion of the fixing portion 28A in an opposite direction from the cell body 18, and has a substantially L-shaped cross section. Battery cells 16 that are adjacent to each other in the lengthwise direction of the battery case 12 are clamped by the busbar 24 in a state in which the flat plate portions 28B of the external terminals 28 thereof are overlaid on each other in the heightwise direction of the battery case 12, and are welded to the busbar 24 at the weld site W. Note that in FIG. 5, to facilitate viewing, only one set of external terminals 28 is illustrated, and only one busbar 24 is illustrated.

In the second modification that is illustrated in FIG. 6, an external terminal 30 has a substantially L-shaped cross section that is similar to the first modification, and is made up of a fixing portion 30A and the flat plate portion 30B. Battery cells 16 that are adjacent to each other in the lengthwise direction of the battery case 12 are clamped by the busbar 24 in a state in which the flat plate portions 30B of the external terminals 30 thereof are butted against each other in the lengthwise direction of the battery case 12, and are welded to the busbar 24 at two weld sites W that are aligned in the lengthwise direction of the battery case 12. Note that in FIG. 6, to facilitate viewing, only one set of external terminals 30 is illustrated, and only one busbar 24 is illustrated.

Next, the operations and effects of the present embodiment will be described. In the battery pack 10 that is configured as described above, the battery cells 16 that are housed arrayed in the battery case 12 are each provided with an external terminal 22 having a flat plate portion 22C that is flat-plate-shaped. The flat plate portions 22C of the battery cells 16 that are adjacent to each other in the lengthwise direction of the battery case 12 are clamped by a busbar 24 that is clip-shaped, and are also welded to the busbar 24. In this way, by clamping the flat plate portion 22C of each of the external terminals 22 by the busbar 24, welding can be performed in a state in which a constant gap is provided between each of the flat plate portions 22C and the busbar 24, and also welding can be performed in a narrow space. Therefore, the external terminal 22 and the busbar 24 can be appropriately fixed in a space-saving manner.

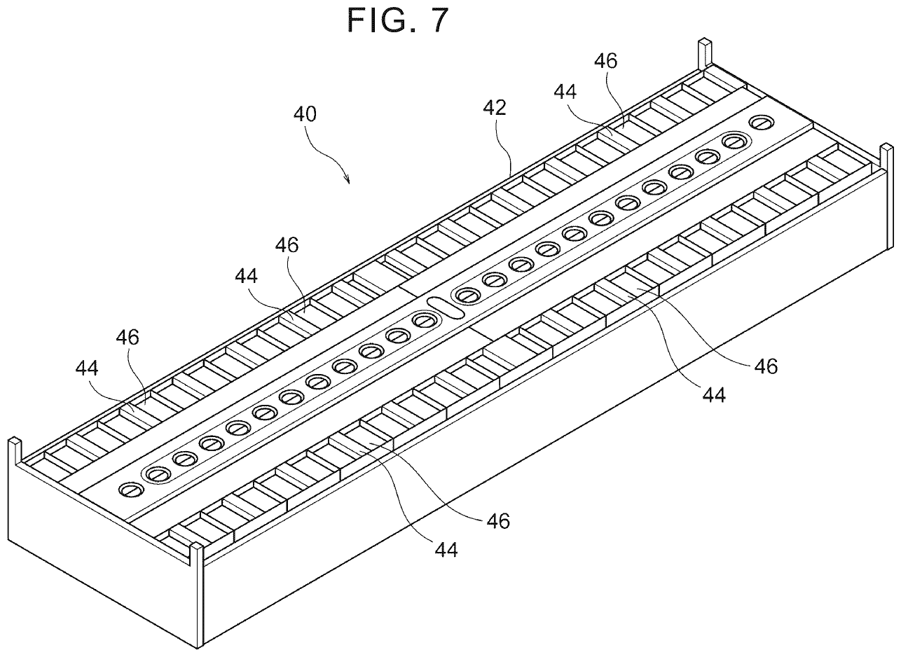

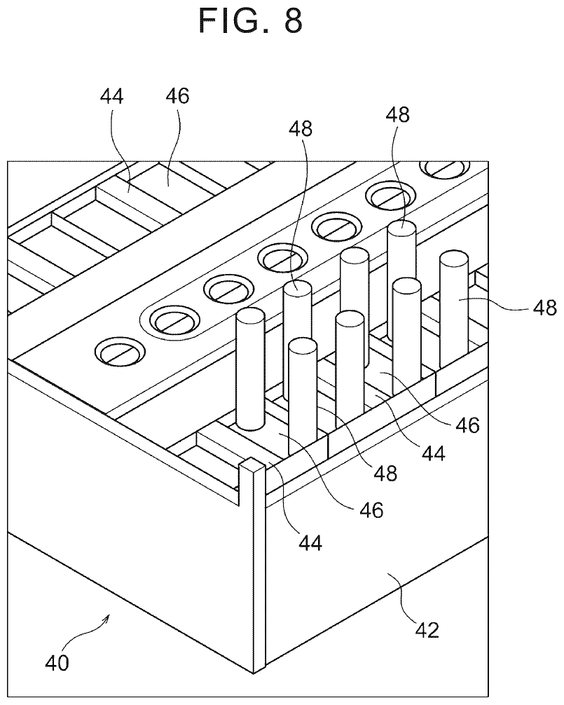

The above effects will be further explained by way of a comparative example illustrated in FIGS. 7 and 8. In a battery pack 40 according to the comparative example, a great number of battery cells 44 are housed in a battery case 42, as illustrated in FIG. 7. An electrode terminal that is omitted from illustration is provided at an upper end portion of each of the battery cells 44, and the electrode terminals of battery cells 44 that are adjacent to each other are connected to each other by a busbar 46. The busbar 46 is pressed against the electrode terminal using a pressing jig 48 as illustrated in FIG. 8, and a gap between the electrode terminal and the busbar 46 is measured. When this gap is within an allowable range, the electrode terminal and the busbar 46 are welded together.

In the case of a configuration like that of this comparative example, space is necessary in the heightwise direction of the battery pack 40. As a result, it becomes difficult to reduce the size of the battery pack 40 in the heightwise direction and to improve stacking efficiency of the battery cells 44 within the battery pack 40, however, in the present embodiment, the pressing jig 48 and the gap measurement that are described above are not necessary, enabling reduction in the size of the battery pack 10 and improve the stacking efficiency of the battery cells 16. Moreover, the terminals and the busbars are not fixed by crimping alone, and accordingly, increase in resistance value due to oxidation of the interface caused by deterioration over time can be suppressed.

Also, in configurations such as the present embodiment and the first modification illustrated in FIG. 5, in a state in which the flat plate portions 22C and 28B of the external terminals 22 and 28 of battery cells 16 that are adjacent to each other are overlaid on each other and clamped by the busbar 24 and welded, space for disposing the external terminals 22 in the lengthwise direction of the battery case 12 can be reduced more easily as compared to the configuration of the second modification illustrated in FIG. 6. On the other hand, in a configuration in a state in which the flat plate portions 30B of the external terminals 30 are butted against each other and clamped between the busbar 24 and welded, as in the second modification illustrated in FIG. 6, each of the flat plate portions 30B is welded to the busbar 24 at two weld sites W, and accordingly each of the flat plate portions 30B can be welded to the busbar 24 equivalently.

Although the present disclosure has been described above by way of embodiment, the present disclosure can be carried out modified variously without departing from the gist thereof. Furthermore, it goes without saying that the scope of the present disclosure is not limited to the above-described embodiment.

What is claimed is:

1. A terminal and busbar fixing structure comprising:
a pair of terminals, each including a flat plate portion that is shaped as a flat plate; and
a clip-shaped busbar that clamps each of the flat plate portions and also is welded to each of the flat plate portions.

2. The terminal and busbar fixing structure according to claim 1, wherein the flat plate portions are clamped by the busbar in a state of being butted against each other.

3. The terminal and busbar fixing structure according to claim 1, wherein the flat plate portions are clamped by the busbar in a state of being overlaid on each other.

4. A battery pack comprising:
a battery case;
a plurality of battery cells that are housed arrayed in the battery case, each of the battery cells including a terminal with a flat plate portion that is shaped as a flat plate; and
a plurality of clip-shaped busbars that clamps each of the flat plate portions of the battery cells that are adjacent to each other, and also is welded to each of the flat plate portions.
